(19) United States
(12) Patent Application Publication
(10) Pub. No.: US 2004/0106368 A1
(43) Pub. Date: Jun. 3, 2004

(54) NEURAL CONDUIT SPINAL CORD REMOVER

(75) Inventor: John E. Johnson, Jefferson, SD (US)

Correspondence Address: BLACKWELL SANDERS PEPER MARTIN LLP, 720 OLIVE STREET, SUITE 2400, ST. LOUIS, MO, 63101, US

(73) Assignee: TYSON FRESH MEATS, INC., Dakota Dunes, SD (US)

(21) Appl. No.: 10/604,306

(22) Filed: Jul. 9, 2003

Related U.S. Application Data
(60) Provisional application No. 60/394,691, filed on Jul. 9, 2002.

(51) Int. Cl. A22C 5/00

(52) U.S. Cl. 452/198

(57) ABSTRACT

An apparatus and method for removing the spinal cord from the animal carcass during processing prior to splitting the carcass. One embodiment of the apparatus includes a catheter tube, which comprises a flexible vacuum casing having a flexible rotating shaft captured therein where a cutting bit member is attached to the tip end of the rotating shaft for breaking down the spinal tissue such that a vacuum can be applied to the catheter to aspirate the spinal cord tissue. The catheter tube can be fed down the spinal channel prior to the carcass being split and as the catheter is being inserted the cutting tip is rotated to break down the spinal tissue and a vacuum is applied to aspirate the broken down tissue. Another embodiment of the apparatus for the concept of removing the spinal cord prior to splitting the carcass comprises a semi-flexible pull line or pull chain/ curly spring. The pull line comprises a stiff long non rotating small diameter spring with a cutting head and connected thereto is a trailing long chain with differing diameter springed cutting edges. The leading edge of the long spring section of the tool is attached to a worm feed line. The method is to feed the worm feed line into the smaller diameter end of the spinal channel and as the worm feed line extends and protrudes out the neck end of the channel the line is grasped and the spring and chain sections are pulled through the channel.

### CROSS REFERENCE TO RELATED APPLICATIONS

Reference to Prior Application(s): This application claims the benefit of U.S. Provisional Application 60/394,691 filed Jul. 09, 2002.

### BACKGROUND OF INVENTION

This invention relates generally to removal of Central Nervous System (CNS) tissue and, more particularly, to removal of spinal cord tissue prior to utilizing Advanced Meat Recovery (AMR) systems to recover lean meat from bones .

AMR systems are utilized to recover or remove remnants of lean meat remaining on bones after the primary carcass disassembly and lean removal operations have been performed. However, many times when the AMR systems are removing lean remnants, other non lean meat by products such as CNS tissue are captured and inadvertently incorporated in the lean meat remnant being removed. Spinal cord tissue is many times the CNS tissue of concern when removing meat remnants from spinal vertebra. Consumer groups have argued that the presence of CNS tissue in lean meat products could cause a public health risk. However, the FSIS has published rules that amends the definition of meat to include products produced from the AMR systems. However, spinal cord tissue is not included within the regulatory definition of meat. Therefore, it is desirable to remove the spinal cord prior to the AMR system operation.

Bovine vertebral columns are often times processed with AMR systems to remove lean meat remnants. Test results have shown that there is often times a presence of spinal cord tissue in lean removed from bone structures which include the bovine vertebra when using a AMR system. Therefore, there is a need for a method and/or system for removing the spinal cord prior to processing a skeletal structure including bovine vertebra with a AMR system.

Currently spinal cords are removed by vacuuming the spinal cord from the spinal channel of a split or halved carcass both on the slaughter/kill floor and the fabrication/cut floor. Manning for this task varies between 1-5 people per shift, depending on the species of animal and the plant. The current process in beef plants is to use large band saws to split the animal carcass along the center of the spinal channel on the slaughter side of the process. The operators are positioned on movable stands which decline to lower the operator as the carcass moves along the line, allowing the operator to move the saw down through the spine. The large saw is somewhat supported by a counter balance line. In order to cut such large and hard bones, the band saw blades are very aggressive thus leading to the possibility of cutting into the spinal tissue and make it difficult for the operator to accurately control the cut. Controlling the large aggressive saw while being lowered by the platform requires a skilled operator in order to split the carcass evenly. A situation arises when mis-splits of the carcass occurs where an additional manual cutting step is performed to remove the mis-split portion of the spinal column that remains and any tissue that remains behind the bone of the mis-split portion of the column. This additional step also requires that an additional inspection be performed to assure that all spinal cord tissue has been removed. This additional cutting step and inspection requires additional manpower.

Another method of removing spinal cords is to remove them with hooks. The process is very labor intensive. A boning hook is used to pull the spinal cord out of the channel. Once this has been done the operator grabs onto the cord and pulls it out of the channel. This labor intensive process has a poor first time yield. Aspirating methods have also been used with low first time yield.

One not skilled in the art would assume that this process sawing or halving the carcass would pulverize the spinal cord, but the opposite is true. The outer sheath of the spinal cord tissue has a highly viscous outer coating such that the spinal cord can move within the cavity of the spinal column sometimes avoiding the saw blade as it passes. There are times when the spinal cord is not cut or the channel is not split down the center, thus leaving the cord encased by the bone and difficult to remove.

A method and system is needed to effectively remove the spinal cord tissue without requiring an additional step and the additional man power.

### SUMMARY OF INVENTION

The invention is method and apparatus for removing the spinal cord from an animal carcass prior to the step of splitting or halving the carcass. The concept of removing prior to splitting involves a method and the apparatus, which includes insertion of a semi-flexible catheter tool or line of semi-flexible material into the spinal channel in order to aspirate the spinal cord material from the spinal channel or extract the cord by pulling, dragging and scrapping the cord from the spinal channel.

There are two primary embodiments for the invention to remove the spinal cord prior to splitting the carcass. The first embodiment of the apparatus includes a catheter tube, which comprises a flexible vacuum casing having a flexible rotating shaft captured therein where a cutting bit member is attached to the tip end of the rotating shaft for breaking down the spinal tissue such that a vacuum can be applied to the catheter to aspirate the spinal cord tissue. The catheter tube can be fed down the spinal channel prior to the carcass being split and as the catheter is being inserted the cutting tip is rotated to break down the spinal tissue and a vacuum is applied to aspirate the broken down tissue.

The second embodiment of the apparatus for the concept of removing the spinal cord prior to splitting the carcass comprises a semi-flexible pull line or pull chain/ curly spring. The pull line comprises a stiff long non rotating small diameter spring with a cutting head and connected thereto is a trailing long chain with differing diameter springed cutting edges. The leading edge of the long spring section of the tool is attached to a worm feed line. The method is to feed the worm feed line into the smaller diameter end of the spinal channel and as the worm feed line extends and protrudes out the opposing end of the channel the line is grasped and the spring and chain sections are pulled through the channel. A larger portion of the spinal cord is taken out as the spring section is pulled through and any significant spinal cord tissue remaining in the channel is chewed up and dragged out by the chain section.

A third embodiment includes a high pressure jet spray rather than a bit to break down the spinal cord material. The jet spray may include multiple streams.

These and other advantageous features of the present invention will be in part apparent and in part pointed out herein below.

### BRIEF DESCRIPTION OF DRAWINGS

For a better understanding of the present invention, reference may be made to the accompanying drawings in which:

FIG. 1 is a side view of the catheter tool illustrating how it is inserted through the spinal channel;

FIG. 2 is a blown up side view of the catheter tool showing a cutting bit member attached to the tip end of the rotating shaft;

FIG. 3 is an isometric view of a section of the catheter with a portion of casing cutaway revealing the rotating shaft and its rotation;

FIGS. 4a-f are various cutting bit designs;

FIG. 5a. is a side view of the pull chain apparatus;

FIG. 5b. is a side view of a section of the pull chain; and

FIGS. 6a-c are various tubular cutting ends

### DETAILED DESCRIPTION

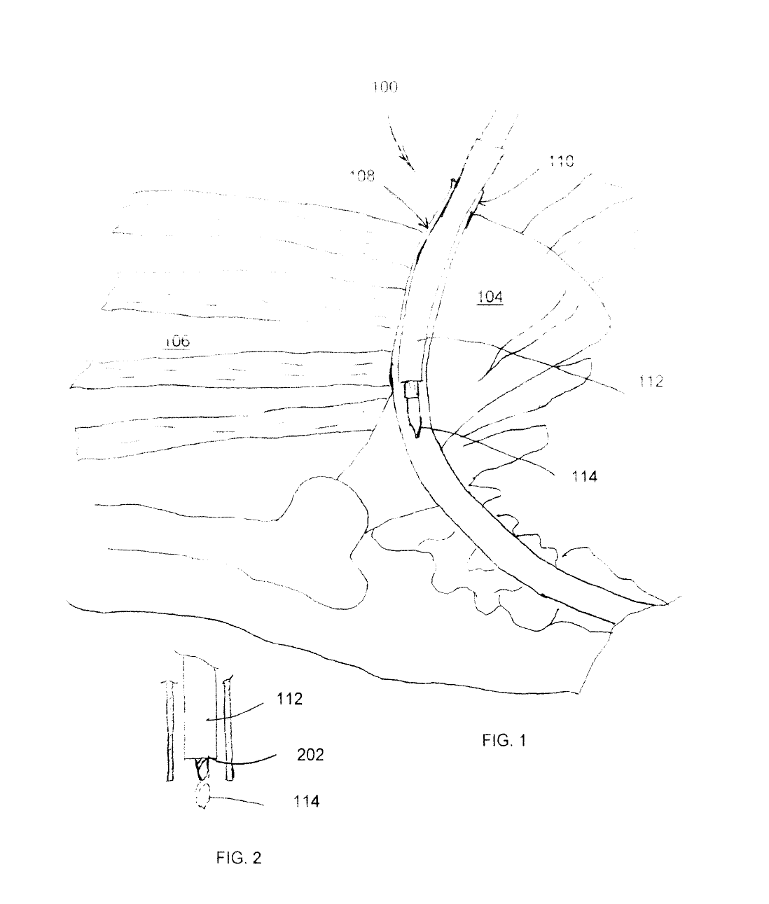

According to the embodiment(s) of the present invention, various views are illustrated in FIGS. 1-5a and like reference numerals are being used consistently throughout to refer to like and corresponding parts of the invention for all of the various views and figures of the drawing. Also, please note that the first digit(s) of the reference number for a given item or part of the invention should correspond to the FIG. number in which the item or part is first identified.

One embodiment of the present invention comprising a flexible vacuum casing having a flexible rotating shaft captured therein where a cutting bit member is attached to the tip end of the rotating shaft for breaking down the spinal tissue such that a vacuum can be applied to the catheter to aspirate the spinal cord tissue, which teaches a novel apparatus and method for removing a spinal cord from an animal carcass. The catheter tube can be fed down the spinal channel prior to the carcass being split and as the catheter is being inserted the cutting tip is rotated to break down the spinal tissue and a vacuum is applied to aspirate the broken down tissue.

A second embodiment of the apparatus for the concept of removing the spinal cord prior to splitting the carcass comprises a semi-flexible pull line or pull chain/ curly/spiral spring. The pull line comprises a stiff long non rotating small diameter spring with a cutting head and connected thereto is a trailing long chain with differing diameter springed cutting edges. The leading edge of the long spring section of the tool is attached to a worm feed line. The method is to feed the worm feed line into the smaller diameter end of the spinal channel and as the worm feed line extends and protrudes out the opposing end of the channel the line is grasped and the spring and chain sections are pulled through the channel. A larger portion of the spinal cord is taken out as the spring section is pulled through and any significant spinal cord tissue remaining in the channel is chewed up and dragged out by the chain section.

Yet a third embodiment of the present invention comprising a flexible vacuum casing having a flexible high-pressure tubing captured therein where a high-pressure member is attached to the tip end of the flexible high pressure tubing and in fluid communication with said tubing for delivering a high pressure jet spray for breaking down the spinal tissue such that a vacuum can be applied to the catheter to aspirate the spinal cord tissue, which teaches a novel apparatus and method for removing a spinal cord from an animal carcass. The catheter tube can be fed down the spinal channel prior to the carcass being split and as the catheter is being inserted the high-pressure nozzle emits a jet spray of fluid sufficient to break down the spinal tissue and a vacuum is applied to aspirate the broken down tissue. One embodiment can deliver an effective jet spray of fluid from a pressure of about 7000 psi. Optionally the jet spray nozzle may have a rotating head and/or may have multiple jet streams emitted for creating an optimal pattern. The fluid emitted can be liquid or gas.

The details of the invention and various embodiments can be better understood by referring to the figures of the drawing. Referring to FIG. 1, is a side view of the catheter tool illustrating how it is inserted through the spinal channel is shown. The catheter tool is shown positioned on top of a drawing of the fore shank and shoulder portions of the carcass to illustrate how the catheter tool is inserted through the spinal cord channel. The drawing reflects the portion of the spinal cord channel 108 that extends through the rib area 106 and the shoulder blade area 104. The catheter tool 100 includes a flexible vacuum casing 110 and interior the flexible vacuum casing 110 is a rotating semi-flexible shaft 112 that extends through the vacuum casing 110. Connected to the end of the rotating shaft 112 is a cutting bit member 114. The catheter tool 100 is inserted through the entire length of the spinal channel during which the rotating shaft rotates the cutting bit to break down the spinal cord. A vacuum is applied to the flexible vacuum casing in order to vacuum the spinal cord material up through the catheter tool. FIG. 1 shows the rotating shaft 112 and the cutting bit 114 connected thereto retracted in the vacuum casing whereas during operation the cutting bit and the rotating shaft can extend further through the vacuum casing thereby extending the cutting bit beyond the vacuum casing in order to engage the spinal cord just prior to vacuuming. The catheter tool is extended completely through the spinal cord channel from the back end through the front end extending through the neck area and atlas bone.

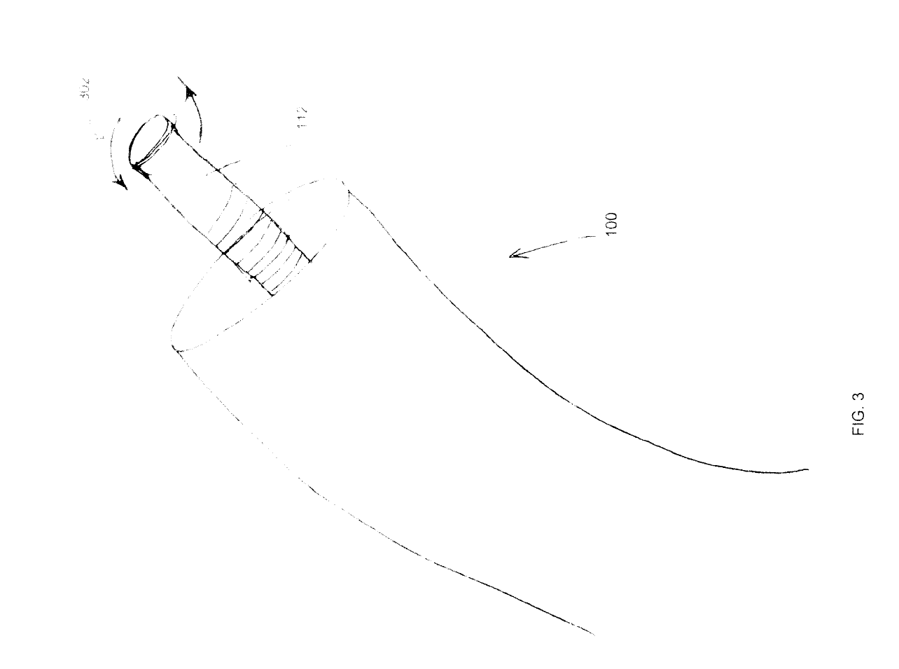

Referring to FIG. 2, a blown up side view of the catheter tool showing a cutting bit member 114 attached to the tip end 202 of the rotating shaft 112 is shown. The side view of the catheter tool is blown up to provide a clearer picture of a cutting bit. The cutting bit is attached to the tip end of the rotating shaft. A more aggressive or less aggressive cutting bit can be chosen depending on the particular animal carcass in question. The rotating shaft can also include barbed wires extended outward from the shaft to facilitate removal of the cord.

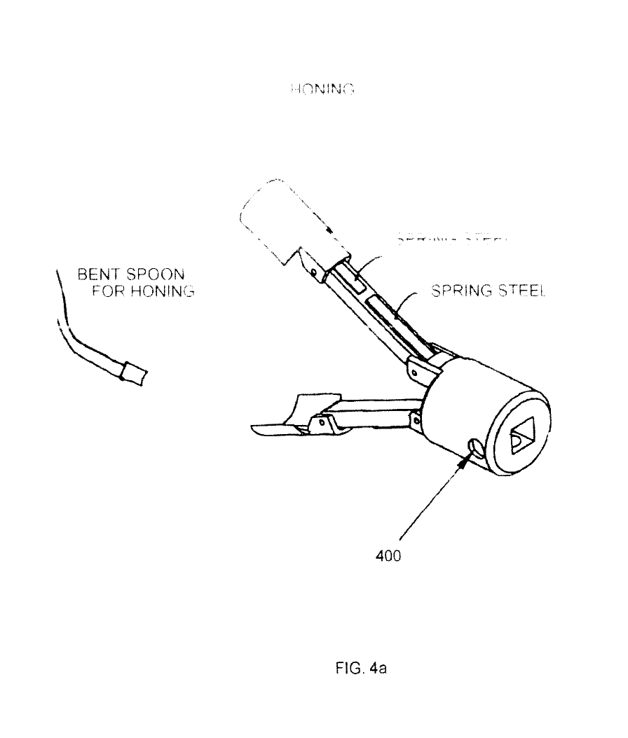

Referring to FIG. 3, an isometric view of a section of the catheter 100 with a portion of casing cutaway revealing the rotating shaft 112 and its rotation is shown. The rotation 302 of the rotating shaft is shown to illustrate the rotating action provided to the cutting bit by the rotating shaft.

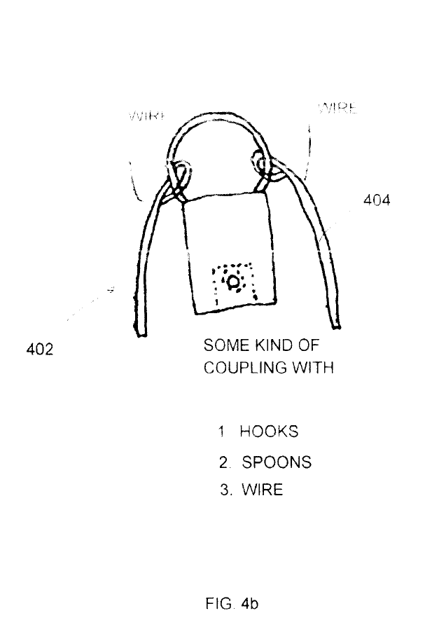

Referring to FIGS. 4a-f, various cutting bit designs are shown. FIG. 4a shows a spring loaded honing cutting bit 400. FIG. 4b shows a cutting bit 402 having free hanging wires 404 extending therefrom that extend outward from the bit as the bit rotates thereby creating a weed whacking action. FIGS. 4c-4f show various other cutting bit designs. The auger bit designs can have blades preceding the auger bit such that the auger bit feeds large bits of the spinal cord towards the blades for mincing prior to vacuuming the debris.

Listed below are various spinning drill bits, that can be driven by a flexible shaft: 1. “Helicopter” This was a bullet shaped tool with free swiveling small spoons or disks attached to the sides. The idea was to spin this fast enough to get the blades to chop up the cord. Since everything was so small and fragile to make it up to the narrow end towards the tail, the tooling easily lodged in between the spaces between vertebras.

2. “Weed Whacker” This tool was similar to the “helicopter” but instead of blade, we used small diameter stainless weld rod. This also proved out to be fairly fragile.

3. “Honing” We developed a miniature articulating (spring loaded) honing tool. The parts on this tool ended up not making through our preliminary testing here at Dakota Technology.

4. “Fluted Tree” This tool was modified from a step drill bit. Testing was promising in that we found a good combination of flex and vibration from the tool itself. The thinking here was to be able to wobble or snake around the inside canal and be able to relieve the sheathing and cord from the nerve endings. The tool however proved to be too long and would not progress past the first radius up from the neck.

5. “Fluted Bullet” This tool was about half the length of the fluted tree and is machined such that it has two flutes on either side. Very successful in going from the neck and making the radius turns up the canal. However, when we split the carcass, it showed that we had not chewed up the cord like we anticipated. Ned a more aggressive tool.

6. “Swing Cutter” This is the latest in the designs of hard tool bits. It will be the same length of the bullet to maneuver, and have an articulating sharp edged piece that swings out into position as you raise the rpm's of the drive. We are currently working on the design of this part and hope to get it to the machine shop soon. After preliminary testing here, we will set up another trip to Lexington.

Brushes mounted to the end of a flexible shaft.

7. “Bottle-Brush” Develop a tool flexible enough to snake into the canal and chew up the cord. Some concerns are flexibility vs. integrity, and how to get the tool sturdy enough and still not lose bristles. We are trying to get something designed and fabricated to test on the next trip.

8. “Rifling” Looks similar to the bottlebrush concept with differing cutting materials and shapes. Hoping to get some differing tool tips made up for testing soon.

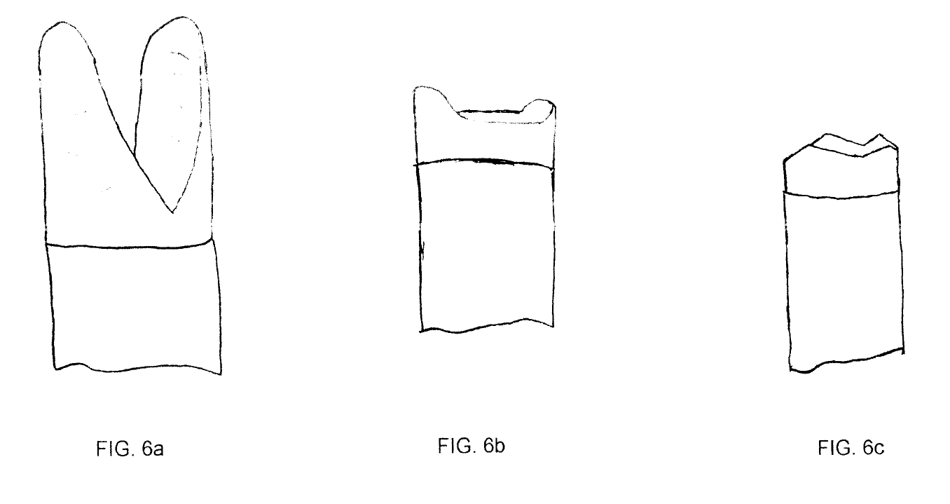

The cutting implement can be integral with the flexible vacuum casing tubing rather than having a rotating shaft and bit. Referring to FIGS. 6a and 6c, various cutting implement configurations are shown which are integral with the tubing. The cutting implement extends from the insertion or leading end of the vacuum tubing for engaging and breaking down the spinal material. The implement can have various designed sharp leading edges as shown in FIGS. 6a-6c. As shown in FIGS. 6a 6c, the substantially tubular blades having various cutting edge designs extend from the rim of one end opening of the flexible vacuum casing tubing where the tubular blades have an outer cylindrical diameter proximate the outer diameter of the vacuum tubing. FIG. 6a shows a v-shaped tubular cutting implement. FIG. 6b shows a two edge cutting implement. FIG. 6c. shows a jagged or saw tooth tubular cutting implement. With this embodiment the vacuum tubing could be designed to rotate to assist in breading down the spinal cord material.

A rotating head or nozzle with fluid pressures around about 7000 psi and a vacuum pump can also be utilized to provide a jet spray of fluid to break down the spinal cord material. However, large quantities of liquid in the meat may result if liquid is the fluid of choice.

However, an air-mixing valve with the liquid jet head can be utilized for a combination fluid of liquid and gas (such as standard air). High-pressure tubing in communication with a vacuum pump can be utilized to deliver a high pressure fluid to a nozzle attached to one end and in fluid communication with the tubing. The nozzle can provide one or more jet streams of fluid and the nozzle streams can be rotating or non rotating. Various nozzle designs can be used to get the desired spray pattern. This along with a good vacuum could eliminate/reduce the added liquid.

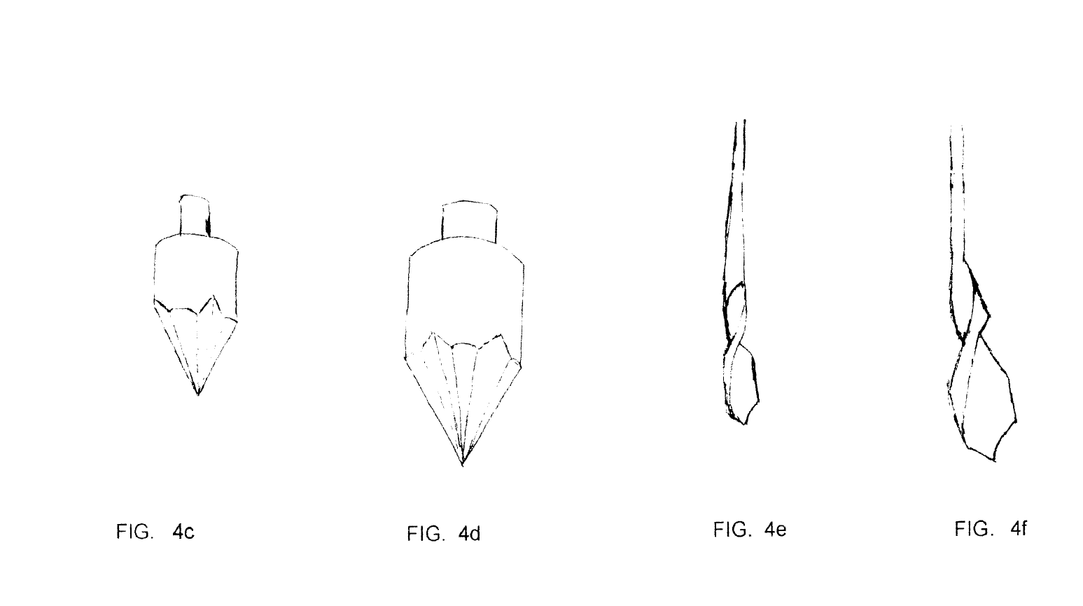

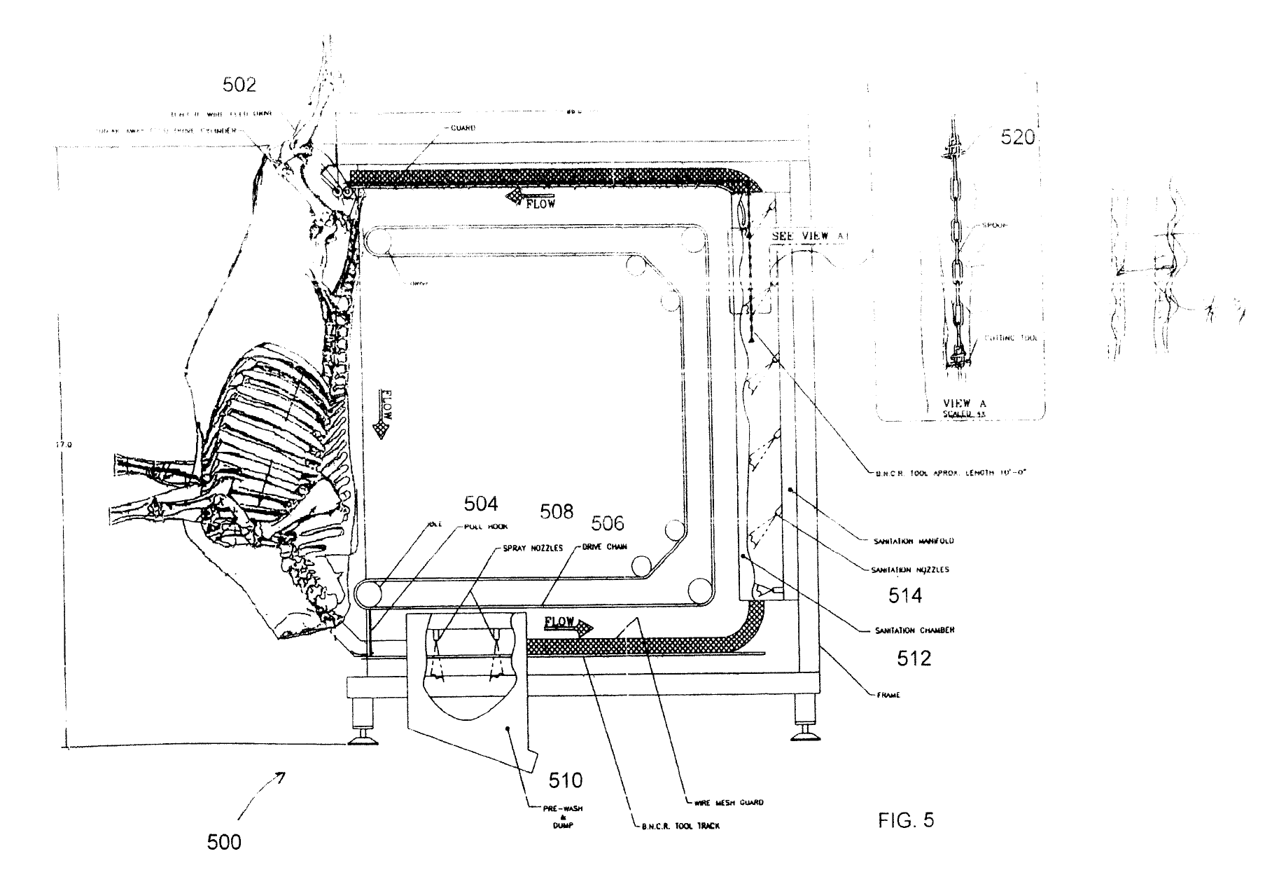

Referring to FIG. 5a, a side view of the pull chain apparatus is shown. An automated pull chain apparatus 500 is shown. The apparatus 500 comprises a wire feed drive 502 which feeds a worm feed line through the spinal cord channel starting at the rear end of the carcass and extending downward through the front end of the carcass where the pull hook grabs the worm line and pulls the pull chain through the spinal cord channel. The drive chain 506 powers the pull hook 504 thereby pulling the pull chain completely through the spinal cord channel. Spray nozzles 508 spray the pull chain at a prewash station 510 to remove the larger portion of the spinal cord tissue from the pull chain. The pull chain continues through a sanitation station 512 having sanitation nozzles 514 for final sanitization of the pull chain prior to being inserted through a subsequent spinal cord channel of a subsequent carcass.

Referring to FIG. 5b, a side view of a section of the pull chain is shown. A blown up view of the pull chain is shown. The pull chain is shown with springed cutting tools spaced along the length of the chain and the springed cutting tool has a spiral configuration of varying diameter. The pull chain can also be inserted and pulled through manually.

The concept utilizes a stiff non-rotating long small diameter spring with a bullet/cutting head. Using a worm feed to insert the spring, it would be fed into the smaller diameter end (bung end) and as it protrudes out the neck end, grab the spring and allow the line to pull the spring through. The idea is to feed a spring through and have an attached chain about the same length with several differing diameter springed cutting edges 520 on the trailing piece. What doesn't get taken out with the fed spring would be chewed up and dragged out with the second section.

“Flex-Spear” Much like the above curly spring idea, but instead of driving a spring into the cow, we insert by hand, a flexible wire/shaft through to the end and similarly pull it through with an additional attached chain w/cutters.

The various spinal cord removal system examples shown above illustrate an effective way to remove the spinal cord tissue from a carcass prior to splitting of the animal carcass. A user of the present invention may choose any of the above spinal cord removal embodiments, or an equivalent thereof, depending upon the desired application. In this regard, it is recognized that various forms of the subject spinal cord removal system for removal prior to splitting could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

1. An apparatus for removing spinal cord material from a carcass of an animal comprising:
an elongated flexible tube forming a vacuum casing;
a flexible rotatable shaft extending through said tube and captured therein;
and
a cutting bit attached to a tip end of the shaft and extending from the tube operable for engaging and breaking down a spinal cord material sufficient for vacuuming.

2. The apparatus for removing spinal cord material as recited in claim 1 where the cutting bit is an auger style bit.

3. The apparatus for removing spinal cord material as recited in claim 1 where the cutting bit is a drill style bit.

4. The apparatus for removing spinal cord material as recited in claim 1 where the elongated flexible tube is in communication with a vacuum source.

5. The apparatus for removing spinal cord material as recited in claim 1 where the rotatable shaft is operably attached to a rotation drive for effecting rotation of the shaft and bit.

6. A method for removing spinal cord material from a carcass of an animal comprising the steps of:
inserting an elongated flexible tube vacuum casing through a spinal channel of a carcass where said tube has a flexible rotatable shaft extending there through and a cutting bit attached to a leading tip end of the rotatable shaft;
driving rotation of the rotatable shaft and bit attached thereto with a rotation drive for breaking down a spinal cord material;
and
applying a vacuum for extracting spinal cord material with a vacuum source in communication with the elongated flexible tube vacuum casing.

7. The method for removing spinal cord material as recited in claim 6 further comprising the steps of:
inserting a feed line through the spinal canal of an animal carcass where said feed line has a pull chain attached to a trailing edged of the feed line; and
pulling the feed line and pull chain attached thereto through the spinal channel where said pull chain has linkages of spiral spring cutting head implements.

8. The method for removing spinal cord material as recited in claim 6 further comprising:
inserting an elongated tube vacuum casing through the spinal channel of a carcass where said elongated flexible tube has a flexible high pressure tubing extending there through and a high pressure nozzle in fluid communication with said high-pressure tubing and attached to one end of the high pressure tubing for emitting a high pressure jet spray;
emitting the high pressure jet spray at a pressure sufficient to break down the spinal cord material for vacuuming out; and
applying a vacuum to the flexible tube vacuum casing for extracting the spinal cord material.

9. An apparatus for removing spinal cord material from a carcass of an animal comprising:
a pull chain having linkages of spiral spring cutting head implements; and
a feed line attached to an end of the chain for insertion through the spinal canal and pulling the pull chain through.

10. The apparatus for removing spinal cord material as recited in claim 9 where the pull chain further having linkages of spiral spring cutting head implements with differing diameter cutting edges.

11. The apparatus recited in claim 9 further comprising:
a line drive for pulling the feed line and chain through the canal; and
a sanitization system having high-pressure spray nozzles proximately disposed to the pull chain after it exits the carcass operable to spray sanitizer solution on the pull chain for sanitizing and removing debris.

12. A method for removing spinal cord material from an animal carcass comprising the steps of:
inserting a feed line through the spinal canal of an animal carcass where said feed line has a pull chain attached to a trailing edge of the feed line; and
pulling the feed line and pull chain attached thereto through the spinal channel where said pull chain has linkages of spiral spring cutting head implements.

13. The method for removing spinal cord material as recited in claim 12 further comprising the steps of:
sanitizing the pull chain with a sanitizer solution.

14. An apparatus for removing spinal cord material from a carcass of an animal comprising:
an elongated flexible tube forming a vacuum casing; and
a flexible high-pressure tubing extending through said elongated flexible tube and captured therein for channeling and delivering fluid under high pressure to a high pressure nozzle for emitting a jet spray of fluid sufficient to break down a spinal cord material for vacuuming through the elongated flexible tube.

15. The apparatus for removing spinal cord material as recited in claim 14 further comprising:
A vacuum source in communication with the elongated flexible tube forming a vacuum.

16. The apparatus as recited in claim 15 further comprising:
a high pressure fluid source in fluid communication with said high-pressure tubing.

17. A method for removing spinal cord material from a carcass of an animal comprising the steps of:
inserting an elongated flexible tube vacuum casing through the spinal channel of a carcass where said elongated flexible tube has a flexible high pressure tubing extending there through and a high pressure nozzle in fluid communication with said high-pressure tubing and attached to one end of the high pressure tubing for emitting a high pressure jet spray;
emitting the high pressure jet spray at a pressure sufficient to break down a spinal cord material for vacuuming out; and
applying a vacuum to the flexible tube vacuum casing for extracting the spinal cord material.

18. An apparatus for removing spinal cord material from a carcass of an animal comprising:
an elongated flexible tube forming a vacuum casing;
a cutting implement attached to an end opening of the leading end of the tubing and extending from the rim of the opening of the tubing operable for engaging and breaking down a spinal cord material sufficient for vacuuming.
